(19) United States
(12) Patent Application Publication
(10) Pub. No.: US 2009/0166098 A1
(43) Pub. Date: Jul. 2, 2009

(54) Non-visual control of multi-touch device

(75) Inventor: Ashwin Sunder, Palo Alto, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/006,172

(22) Filed: Dec. 31, 2007

(51) Int. Cl. G06F 3/043

(52) U.S. Cl. 178/18.04

(57) ABSTRACT

This relates to electronic devices that include a multi-touch user interface component. More specifically, this relates to portable media devices that enable a user to listen to music, facilitate telephone conversations, send and receive electronic messages, and utilize a multi-touch input panel in an eyes-free manner. A user may use a multi-touch user input component to navigate a menu system absent a functioning display screen, virtual buttons or any other visual cues or prompts. Audio cues, portions of prerecorded songs, and any other type of audio information may help the user to mentally map and quickly navigate the device's menu system.

### FIELD OF THE INVENTION

This relates to electronic devices that include a multi-touch user interface component. More specifically, this relates to navigating an electronic device's menu system using a multi-touch user interface component in the absence of a visual display.

### BACKGROUND OF THE INVENTION

Electronic devices are a staple of modern society. Every day, millions of people use cellular telephones, desktop computers and digital music players. As technology and innovation forge ahead, display screens become more engaging, devices become more portable, and processors become faster. One electronic device was recently lauded as being revolutionary for successfully combining these three things. That device is Apple Inc.'s iPhone™. (Apple Inc. owns the iPhone™ trademark.) The iPhone™ is a portable electronic device that combines processing power and a single multi-touch display screen in a portable package.

Multi-touch display screens usually include a transparent touch panel and visual display component. The touch panel comprises a touch sensitive surface and is often positioned in front of the display screen. In this manner, the touch sensitive surface covers the viewable area of the display screen and, in response to detecting a touch event, generates a signal that can be processed and utilized by other components of the electronic device. Multi-touch display screens are discussed in more detail in commonly assigned U.S. Patent Publication No. US 2006/0097991, entitled “MULTIPOINT TOUCHSCREEN,” which is incorporated by reference herein in its entirety.

Multi-touch display screens are frequently configured to display virtual buttons and other types of options to the user. The user may select a virtual button by tapping the multi-touch display screen where the virtual button is being displayed. The locations, shapes and sizes of virtual buttons, unlike physical buttons, can be dynamic and change as the user navigates through the menu system of the electronic device. This allows the same physical space to represent different buttons at different times.

Despite the shape, size and location of virtual buttons changing, the user can only feel the smooth, hard surface of the multi-touch display screen. For obvious reasons, a user who is permanently visually impaired (e.g., blind) or often temporally visually impaired may prefer to use an electronic device that has physical buttons because physical buttons can be located based on touch alone. As used herein, the phrase “temporally visually impaired” refers to a user who is physically capable of seeing, but is unable to see or would rather not divert his attention to his electronic device's display screen (because, e.g., the user is operating a motor vehicle, the electronic device is in the user's pocket, etc.).

Some electronic devices, such as automated teller machines (“ATMs”), combine static tactile feedback (such as Braille) with audible instructions to help visually impaired people use the devices. But the audible instructions are inefficient and can be frustrating. For example, a user may have to listen to a long list of options before the user is able to determine which option is best. Once the user hears the option the user wants to select, the user must search for the right physical button using touch alone.

The present invention improves on the devices discussed above as well as on others.

### SUMMARY OF THE INVENTION

The present invention includes methods, systems, computer readable media and means for receiving and converting physical stimuli into electrical data signals. The physical stimuli can take any form, including touch stimuli. The present invention may utilize a multi-touch input component to receive the physical stimuli and enable a user to navigate a menu hierarchy that is implemented by an electronic device.

In some embodiments of the present invention, the multi-touch input component may be opaque or transparent. The multi-touch input component can also lack a visual display component. In other embodiments, the multi-touch input component can include a multi-touch panel and a visual display component.

Regardless of whether a visual display component is utilized by the present invention, the present invention can enable non-visual navigation of the menu hierarchy. The multi-touch input component can be activated in response to an ongoing enabling touch event. When the enabling touch event ceases, the multi-touch input component can be deactivated, thereby preventing the electronic device from receiving any inputs from the multi-touch input component.

In addition to an enabling touch event, the multi-touch input component may be automatically enabled in response to other physical stimuli. For example, the presence of ambient light, the proximity of another object to the device, the device's remaining battery power, the current and/or previous acceleration of the device, the speed of the device (which may be determined by using a global positioning sensor), and/or any other physical stimuli can be used to activate a non-visual device and/or a non-visual mode of a device that has a visual display screen. While in the non-visual mode, the present invention does not use its visual display screen. Instead, it can enable the user to mentally map the device's menu hierarchy by providing responsive audio signals. The audio signals can be converted into audio information that is presented to the user by a speaker. The speaker can be integrated into the device and/or an accessory device.

When the multi-touch input component is enabled, the present invention may determine where one or more of the user's finger tips are touching the multi-touch input component. The fingertip location(s) can be translated into initial points of contact and used to generate initial location data point(s). Each initial location data point can be recalled and used to analyze the movement of a finger tip. A touch signal can then be generated based on which fingertip moved, the type of movement and the relative direction of the movement.

The present invention can also utilize one or more storage components that store various types of data. For example, menu data, media data, location data and/or any other type data can be stored in the storage component(s).

The menu data can include and/or incorporate various types of audio data. A processor of the electronic device can process the audio data into an audio signal, which can be converted into audio information that a user can hear. The audio information can enable a user to mentally map and quickly navigate the menu hierarchy implemented by the electronic device. In this manner, mental mapping can be achieved absent a functioning visual display component.

For example, various menus and menu options can be associated with specific, unique audio data. When a touch event occurs, the electronic device generates an audio signal. The audio signal, once converted to audio information, may sound like a chime, musical song, or a spoken language. Over time, the user can learn to associate different sounds with different menus and options.

### SUMMARY OF THE DRAWINGS

The above and other features of the present invention, its nature and various advantages will be more apparent upon consideration of the following detailed description, taken in conjunction with the accompanying drawings, in which like reference characters refer to like parts throughout, and in which:

FIGS. 1-2 are illustrative systems in accordance with some embodiments of the present invention;

FIG. 3 shows an illustrative cross sectional view of an electronic device in accordance with some embodiments of the present invention;

FIG. 4 is a simplified schematic block diagram of an illustrative embodiment of circuitry in accordance with the present invention;

FIGS. 5a and 5b are a simplified logical flow of an illustrative mode of operation of circuitry in accordance with some embodiments of the present invention;

FIGS. 6-7 are illustrative examples of ways to provide inputs to electronic devices in accordance with some embodiments of the present invention; and

FIGS. 8-12 are simplified navigational flows of a menu hierarchy that can be implemented in some embodiments of the present invention.

### DESCRIPTION OF THE INVENTION

Recent developments in technology allow smaller electronic devices to have increased functionality. However, as more functionality is packed into smaller devices, the user interface component(s) of the electronic devices (e.g., keyboard, number pad, click wheel, etc.) are becoming the limiting factor.

One solution is to utilize a multi-touch user interface component. A multi-touch user interface component enables the same physical space to be used in a plurality of manners. A single multi-touch user interface component can be used instead of a plurality of other user input and display components.

However, as discussed briefly above, multi-touch user interface components can present various challenges to visually impaired users, especially when the multi-touch user interface is used in conjunction with a display screen.

Dynamic haptic feedback, for example, can help a visually impaired user find a virtual button on a smooth multi-touch display screen. Dynamic haptic feedback can enable a visually impaired user to feel what is being displayed, locate a virtual button and select the virtual button by tapping it. Systems, methods and computer readable media for combining dynamic haptic feedback with a multi-touch display screen are discussed in more detail in commonly assigned U.S. patent application Ser. Nos. ______, entitled “TOUCHSCREEN DISPLAY WITH LOCALIZED TACTILE FEEDBACK” (client docket no. P4994US1) and ______, entitled “TACTILE FEEDBACK IN AN ELECTRONIC DEVICE” (client docket no. P5345US1), which are hereby incorporated by reference in their entireties.

Although the present invention could be used in conjunction with dynamic haptic feedback, the present invention could just as easily be used in the absence of all types haptic feedback. The present invention provides systems, methods, computer readable media and means for enabling a visually impaired user to utilize and enjoy the benefits of an electronic device that has a multi-touch user interface component without the need of haptic feedback.

Some embodiments the present invention can be implemented in an electronic device that utilizes a multi-touch display screen. An example of such a device is the iPhone™. In some of these embodiments, the present invention can be activated in response to, for example, the electronic device determining that the user is permanently or temporally visually impaired (e.g., the user responds to a prompt in a manner that indicates the user is blind or driving a motor vehicle). As another example, the present invention may be activated in response to the electronic device determining that it is in a non-visual mode. An electronic device can enter a non-visual mode in response to, for example, a user indication to do so. As another example, the electronic device can enter a non-visual mode when its display screen is not functioning properly, and/or in response to the electronic device automatically determining that the user is unable to see or should not look at the display screen.

The electronic device may, for example, utilize additional sensors (e.g., proximity sensor, digital camera, ambient light sensor, etc.) to automatically determine if the user can or should not be looking at the display screen. For example, the electronic device may automatically enter a non-visual mode based on data the electronic device receives from its proximity and ambient light sensors. The combination of outputs from proximity and ambient light sensors can enable the electronic device to determine that the display screen is pressed against something that light cannot pass through (such as, e.g., the user's pocket). As another example, the electronic device may utilize a battery power sensor to determine whether the electronic device should enter the non-visual mode (and, e.g., enter the non-visual mode when there is little remaining battery power). As yet another example, the electronic device may utilize a global positioning sensor and/or accelerometer to determine that the user is driving a motor vehicle and, in response, enter a non-visual mode. Automatically adjusting the operational modes of an electronic device in response to various sensor outputs is discussed further in commonly assigned U.S. patent application Ser. No. ______, entitled “EVENT-BASED MODES FOR ELECTRONIC DEVICES” (hereinafter referred to by its client docket no. “P4788US1”) and U.S. patent application Ser. No. ______, entitled “PERSONAL MEDIA DEVICE INPUT AND OUTPUT CONTROL BASED ON ASSOCIATED CONDITIONS” (hereinafter referred to by its client docket no. “P5355US1”), both of which are incorporated herein by reference in their entireties.

Despite the present invention having the potential to be used in conjunction with a graphical user interface display, the present invention could just as easily be used in the absence of a graphical or other visual display. The present invention provides systems, methods, computer readable media and means for enabling a visually impaired user to utilize and enjoy the benefits of an electronic device that lacks a visual display component but has a multi-touch user interface component.

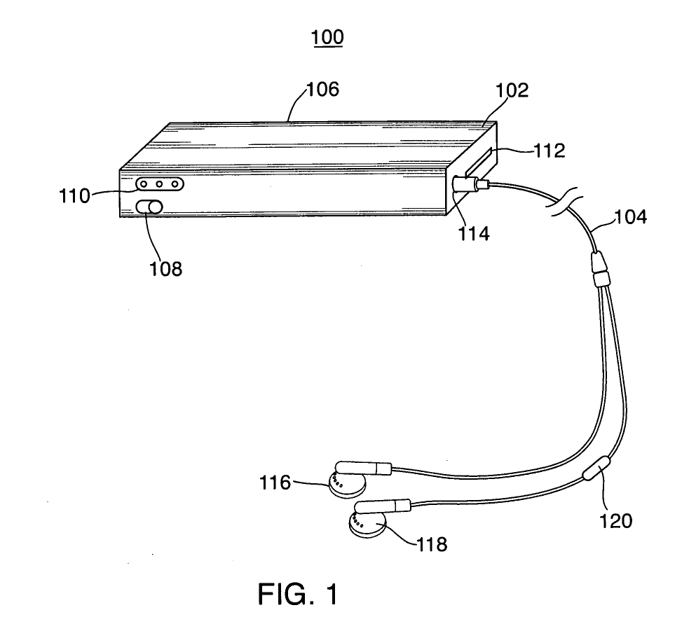

FIG. 1 shows system 100, which is one exemplary embodiment of the present invention. System 100 includes portable media device 102 and accessory device 104.

Portable media device 102 can be an electronic device that receives, stores and plays back media files (e.g., audio files, video files, and/or any other type of media files). Portable media device 102 can also function as a communications device that can facilitate telephone calls, send and receive electronic messages (such as, e.g., text and e-mail messages), communicate with satellites (to, e.g., provide driving directions, radio programming, etc.), and/or communicate with any other type of device or server in any manner. Portable media device 102 may be, for example, a multi-touch hybrid device that has a display screen (like the iPhone™) or an innovative multi-touch hybrid device that does not have a display screen.

Electronic devices that include a multi-touch input component and do not include a display screen are sometimes referred to herein as “non-visual electronic devices.” Non-visual electronic devices that can receive, store and play back media files are sometimes referred to herein as “non-visual media devices.” A non-visual media device may be a hybrid device that also functions as, for example, a communications device.

A number of advantages can be realized by omitting a display screen from an electronic device. For example, the battery life can be extended (since display screens require a relatively large amount of battery power to operate) and the electronic device can assume any shape or size. In addition, omitting a display screen may allow a handheld electronic device to be more robust, durable and more stealthy, which may be appealing to campers, hunters, soldiers and other people who partake in vigorous or covert activities. A non-visual electronic device can also be manufactured and sold for less money than a similar device that has a display screen.

Portable media device 102 is shown in FIG. 1 as lacking a display screen, but includes multi-touch input component 106. Multi-touch input component 106 can wrap around the sides of portable media device 102. Multi-touch input component 106 can generate various touch signals in response to different touch events. A touch event occurs when a pointing apparatus, such as a user's fingertip or stylus, is making physical contact with, disengages from or moves along multi-touch input component 106.

Touch events can differ depending on, for example, the type of motion made by the pointing apparatus, the relative location of the touch event and/or the relative timing of the touch event in relation to other touch events. For example, when a user is holding portable media device 102 with five fingers, each of the five fingers may be acting as an independent pointing apparatus. In other embodiments, two or more of the five fingertips can collectively act as a joint pointing apparatus. For example, the pinky and thumb may be a joint pointing apparatus that generates a device enabling touch event so long as both the pinky and thumb are pressed against multi-touch input component 106. The device enabling touch event can be required to operate portable media device 102. In some embodiments, in response to the pinky and/or thumb disengaging from multi-touch input component 106, portable media device 102 can enter a power saving mode or at least disable multi-touch input component 106.

Multi-touch input component 106 may be configured to determine the location of each pointing apparatus based on its relative position to the other pointing apparatuses. For example, the device may identify the thumb as the only finger on the palm side of portable media device 102, and the pinky fingertip as the fingertip farthest from the thumb's fingertip. This configuration can enable Multi-touch input component 106 to generate different touch signals based on different pointing apparatuses.

In other embodiments, multi-touch input component 106 may only cover a portion of portable media device 102 (instead of wrapping around all sides of portable media device 102). In these other embodiments, portable media device 102 can be configured to have a preferred orientation. The shape of portable media device 102 and/or any special markings (such as, e.g., a label, notch, or protrusion) can be contoured and/or used to indicate a preferred orientation (e.g., where the index, pinky and/or any other finger(s) should be placed).

Multi-touch input component 106 can also be configured to generate different touch signals in response to different types of touch events. Types of touch events can include, for example, a single tap touch, a double tap touch, a slow slide, a fast slide, a circular movement, or any other type of physical motion.

Multi-touch input component 106 can also be configured to generate a single touch signal in response to multiple touch events that occur within a given amount of time (e.g., sequentially, simultaneously or near simultaneously). For example, multi-touch input component 106 can generate a single touch signal in response to the middle finger and index finger nearly simultaneously tapping multi-touch input component 106. The touch signal that is generated in response to the near simultaneous taps is preferably different from the touch signals generated in response to the middle finger or index finger individually tapping.

In addition, multi-touch input component 106 can be used for entry of, e.g., text messages via letter by letter handwriting recognition. Complex tough events can be used to represent various letters in the alphabet as well as punctuation marks. In some embodiments, the present invention, portable media device 102, can announce to the user which letter the user has written.

Portable media device 102 can also include one or more additional input components, such as, for example, switch 108 and wheel 110. Switch 108 can be, for example, a toggle switch that locks and unlocks the other user input components, including multi-touch input component 106. Wheel 110 can be used to, for example, adjust the audio output volume of portable media device 102. In other embodiments, the functionality of switch 108 and wheel 110 can be integrated into multi-touch input component 106 and/or any other type of user interface.

Portable media device 102 may also include additional sensors, such as a proximity sensor, ambient light sensor, accelerometer, pressure sensor, any other sensor that can detect any other physical phenomena, and/or any combination thereof. One or more of these additional sensors (which are not shown in FIG. 1) may be used to detect, for example, the presence of the user's thumb (such as when, e.g., multi-touch input component 106 is not located on all sides of portable media device 102). In this manner, the one or more additional sensors may act as an added guard against accidental user inputs. Additional sensors can also be used for a wide variety of other applications, some of which are discussed in P4788US1 and P5355US1.

Portable media device 102 may also include one or more connector components, such as, for example, 30-pin connector 112 and headset connector 114. 30-pin connector 112 can be used, for example, to couple portable media device 102 to an accessory device, host device, external power source, and/or any other electronic device. A host device may be, for example, a desktop or laptop computer or data server that the portable media device can receive media files from.

Headset connector 114 is shown in FIG. 1 as physically and electrically coupling portable media device 102 and accessory device 104 together. Accessory device 104 can include, for example, speakers 116 and 118. Speakers 116 and 118 can enable the user to hear audio files that are played back using portable media device 102. In some embodiments, accessory device 104 can also include microphone 120. Microphone 120 may allow the user to provide voice commands to portable media device 102, have a telephone conversation, etc. Persons skilled in the art will appreciate that accessory device 104 could also be wirelessly coupled to portable media device 102.

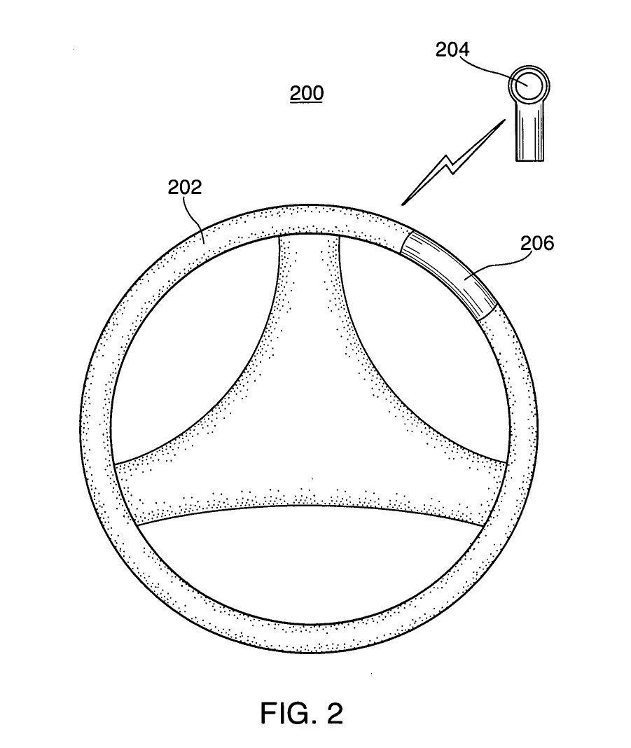

FIG. 2 shows system 200. System 200 includes electronic device 202 and accessory device 204. Electronic device 202 is shown as an automobile steering wheel that also functions as a non-visual multi-touch device. Accessory device 204 can be, for example, a wireless headset that includes a microphone and a speaker. Electronic device 202 and accessory device 204 may be paired together using the Bluetooth™ protocol and wirelessly communicate with each other. In some embodiments, the wireless receiver of electronic device 202 is integrated in the steering wheel, or in any other part of the automobile.

Electronic device 202 includes multi-touch input component 206, which may function the same as or similar to multi-touch input component 106 of FIG. 1. Electronic device 202 may store media files in an integrated storage device and/or access media files stored remotely, such as in the automobile's CD player. Electronic device 202 may also function as remote control for the automobile's stereo system. Persons skilled in the art will appreciate that a multi-touch input component may be integrated into any other type of device or apparatus, such as, for example, a motorcycle's handlebar grip, a bicycle throttle handle, an armrest of a wheelchair, a home stereo remote control, a television remote control, a keyboard, an aircraft control stick, a walking stick, a watch, a universal device that can be fastened around any desired surface, etc.

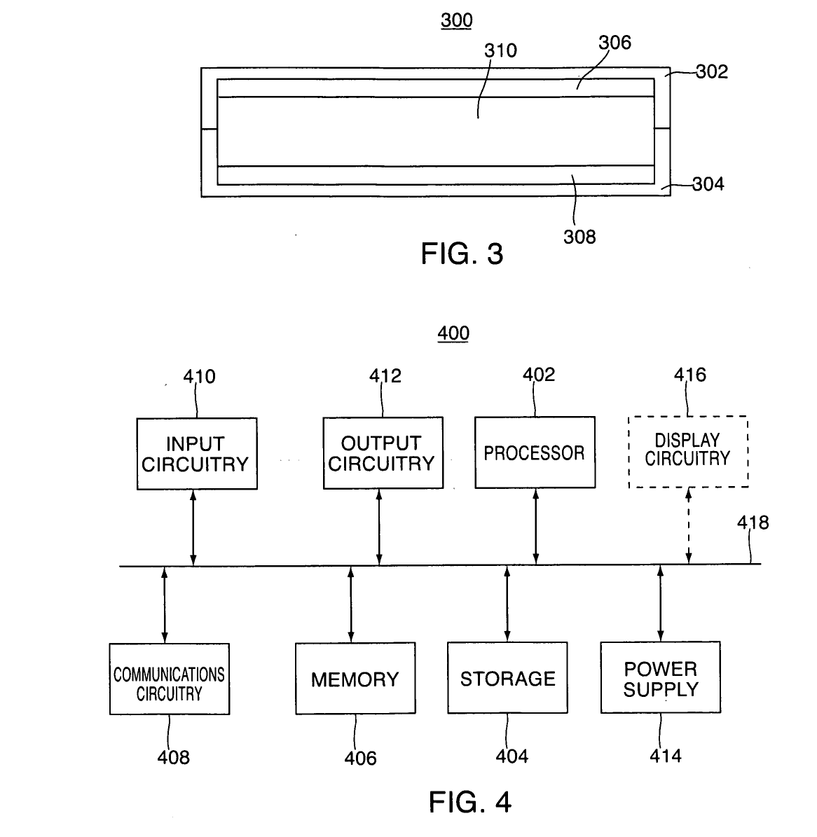

FIG. 3 shows a cross sectional view of electronic device 300. Electronic device 300 is a non-visual electronic device, which may function the same as or similar to portable media device 102 and/or electronic device 202. Electronic device 300 includes top cover 302, bottom cover 304, multi-touch panel 306, proximity sensing layer 308, and internal components area 310.

Top cover 302 and bottom cover 304 may be two different components or a single component that form the outer shell and/or support structure of electronic device 300. Top cover 302 and bottom cover 304 can be formed in any shape, size and thickness. In addition, because electronic device 300 is lacking a display screen, top cover 302 and/or bottom cover 304 can be opaque, transparent or a combination thereof. Top cover 302 and bottom cover 304 can be made from any type of material(s), such as those capable of withstanding impacts or shocks to protect the other components of electronic device 300. The materials used for top cover 302 and/or bottom cover 304 can enhance, or at least not substantially inhibit, the functionality of the other components of electronic device 300. Suitable materials may include, for example, composite materials, plastics, metals, and metal alloys (e.g., steel, stainless steel, aluminum, titanium, magnesium-based alloys, etc.) and/or any other type of material. In addition, top cover 302 and/or bottom cover 304 may be comprised of multiple pieces.

Multi-touch panel 306 may function the same as or similar to multi-touch input component 106 of FIG. 1. Multi-touch panel 306 may, for example, determine that a touch event has occurred, determine the type of touch event (e.g., tap, slide, circular, any combination thereof), determine whether the touch event was a joint touch event (e.g., two pointing apparatuses moving in concert), determine relative location of the touch event, and, in response to some or all of those determinations, generate a corresponding touch signal. The touch signal can be sent to a processor or any other component of electronic device 300.

Proximity sensing layer 308 can detect when bottom cover 304 is in close proximity to or physically touching something, such as, for example, a user's thumb or hard surface. Proximity sensing layer 308 may detect pressure, ambient light, reflective energy, any combination thereof, or anything else.

Internal components area 310 is the portion of electronic device 300 that may house the other internal components of electronic device 300. Examples of such components are discussed in connection with, for example, FIG. 4.

FIG. 4 shows a simplified schematic diagram of electronic device 400. Electronic device 400 can function the same as or similar to portable media device 102, electronic device 202 and/or electronic device 300.

Electronic device 400 can include control processor 402, storage 404, memory 406, communications circuitry 408, input circuitry 410, output circuitry 412, power supply circuitry 414 and/or display circuitry 416. In some embodiments, electronic device 400 can include more than one of each component, but for the sake of simplicity, only one of each component is shown in FIG. 4. In addition, persons skilled in the art will appreciate that the functionality of certain components can be combined or omitted and that additional components, which are not shown or discussed in FIGS. 1-4, can be included in a device that is in accordance with the present invention.

Processor 402 can include, for example, circuitry that can be configured to perform any function. Processor 402 may be used to run operating system applications (including those that implement an audible menu hierarchy), firmware, media playback applications, media editing applications, and/or any other application.

Storage 404 can be, for example, one or more storage mediums, including for example, a hard-drive, flash memory, permanent memory such as ROM, any other suitable type of storage component, or any combination thereof. Storage 404 may store, for example, media data (e.g., music and video data), application data (e.g., for implementing functions on device 200), menu data (used to, e.g., organize data into a menu hierarchy), firmware, user preference data (associated with, e.g., media playback preferences), lifestyle data (e.g., food preferences), exercise data (e.g., data obtained by exercise monitoring equipment), transactional data (associated with, e.g., information such as credit card information), wireless connection data (e.g., data that may enable electronic device 300 to establish a wireless connection), subscription data (e.g., data that keeps track of podcasts or television shows or other media a user subscribes to), contact data (e.g., telephone numbers and email addresses), calendar data, any other suitable data, or any combination thereof. Any or all of the data stored in storage 404 may be formatted in any manner and/or organized as files. Processor 402 can process the data stored on storage 404 into information that can be presented to the user (as, e.g., audible information).

Memory 406 can include, for example, cache memory, semi-permanent memory such as RAM, and/or one or more different types of memory used for temporarily storing data. Memory 406 can also be used for storing any type of data, such as operating system menu data, used to operate electronic device applications and enable the user to interact with electronic device 400.

Communications circuitry 408 can permit device 400 to communicate with one or more servers or other devices using any suitable communications protocol. For example, communications circuitry 408 may support Wi-Fi (e.g., a 802.11 protocol), Ethernet, Bluetooth™, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, GSM, CDMA, SSH, any other type of communications, or any combination thereof.

Input circuitry 410 and output circuitry 412 can be respectively coupled to and/or integrated into various input and output components. Examples of input components include microphones, multi-touch panels, proximity sensors, accelerometers, ambient light sensors, camera and any other component that can receive or detect a physical signal or phenomena. Examples of output components include speakers, visual display screens, vibration generators and any other component that can create a physical signal or phenomena. Input circuitry 410 can convert (and encode/decode, if necessary) physical signals and other phenomena (e.g., touch events, physical movements of electronic device 400, analog audio signals, etc.) into digital data. Similarly, output circuitry 412 can convert digital data into any other type of signal or phenomena. The digital data can be provided to and/or received from processor 402, storage 404, memory 406, or any other component of electronic device 400.

Power supply 414 can provide power to the components of device 400. In some embodiments, power supply 414 can be coupled to a power grid (e.g., a wall outlet or automobile cigarette lighter). In some embodiments, power supply 414 can include one or more batteries for providing power to a portable electronic device. As another example, power supply 414 can be configured to generate power in a portable electronic device from a natural source (e.g., solar power using solar cells).

Display circuitry 416 is a type of output circuitry that can be included or omitted from electronic device 400 without departing from the spirit of the present invention. Display circuitry 416 can accept and/or generate signals for visually presenting information (textual and/or graphical) to a user on a display screen. For example, display circuitry 416 can include a coder/decoder (CODEC) to convert digital data into displayable signals. Display circuitry 416 also can include display driver circuitry and/or circuitry for driving display driver(s). The display signals can be generated by, for example, processor 402 or display circuitry 416. The display signals can provide media information related to media data received from communications circuitry 408 and/or any other component of electronic device 400. In some embodiments, display circuitry 416, like any other component discussed herein, can be integrated into and/or external to electronic device 400. In some embodiments of the present invention, such as those that, for example, lack a functional display component, navigational information and any other information may be audibly presented to the user by electronic device 400.

Bus 418 can provide a data transfer path for transferring data to, from, or between control processor 402, storage 404, memory 406, communications circuitry 408, and any other component included in electronic device 400.

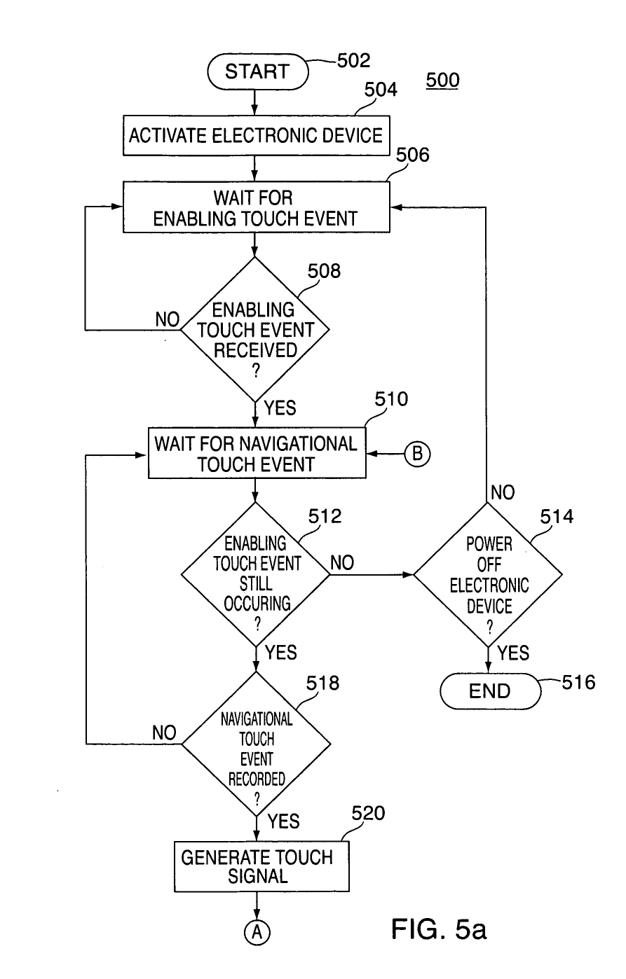

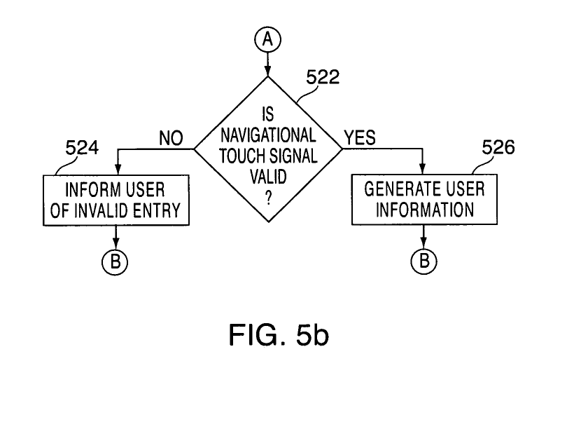

FIG. 5 shows process 500, which is a simplified logical flow of an illustrative method of operation of circuitry in accordance with some embodiments of the present invention. Process 500 begins at step 502.

Next is step 504 at which the electronic device is activated. The electronic device can be any type of electronic device, including a portable media device with or without telephone functionality, that includes a multi-touch input component. The multi-touch input component includes a multi-touch panel and may or may not include a display screen element. As such, the electronic device can be a non-visual device or a device with display screen. The electronic device can be activated in response to, for example, the user pressing a power ON button, a preconfigured event occurring (such as, e.g., an alarm clock), or an incoming telephone call.

After the electronic device has been activated, the device waits at step 506 for an enabling touch event. The electronic device may be in a standby mode or any other type of power saving mode while the electronic device waits for an enabling touch event. Alternatively, the electronic device may be actively functioning (e.g., emitting an alarm, displaying information to the user, communicating with other electronic devices, etc.). Regardless of whether the electronic device is actively functioning or in a power saving mode, the electronic device may ignore all other touch events in the absence of the enabling touch event. In other words, all other touch events may be ignored unless the enabling touch event is present.

At step 508 the electronic device determines whether or not it has received an enabling touch event. An enabling touch event may be generated in response to, for example, the user touching the electronic device's multi-touch panel with one finger (such as, e.g., a pinky finger) or a plurality of fingers. (Persons skilled in the art will appreciate that, although human fingers are often referenced herein, any type of pointing apparatus, including a stylus, writing instrument, paper clip, or anything else that can physically touch a multi-touch panel, can be used to create a touch event.)

The enabling touch event may cause the electronic device to calibrate the multi-touch panel and store one or more initial location data points (e.g., one for each finger). The electronic device may utilize the initial location data point(s) to determine the relative direction of movements by various fingers. The initial location data point(s) can also be used to determine which finger or fingers is/are moving.

The movement associated with touch events can also be measured in absolute terms, wherein a particular portion on the multi-touch panel corresponds with a particular functionality (e.g., similar to how a virtual button is displayed and associated with a portion of the multi-touch panel). In some embodiments of the present invention, movements associated with touch events may have both a relative and absolute component. For example, a portion of the multi-touch panel's real estate can be dedicated to a particular set of functions and, within that real estate, different movements can cause the electronic device to function differently. The electronic device may have grooves (for, e.g., each finger) or other physical contours and attributes that identify the bounds of each portion of the multi-touch panel.

In some embodiments, the enabling touch event can require the processor of the electronic device to receive various other inputs from other components. For example, the enabling touch event may be a combination of, e.g., a pinky finger on the multi-touch panel and a thumb on a proximity sensor. In other embodiments, the enabling touch event may not involve the multi-touch panel.

In response to the electronic device determining at step 508 that it has not received an enabling touch event, process 500 returns to step 506 and the electronic device continues to wait for an enabling touch event. In response to the electronic device determining at step 508 that it has received an enabling touch event, process 500 proceeds to step 510.

At step 510 the electronic device waits to receive a navigational touch event. A navigation touch event can include a physical movement (e.g., tap, press, slide, circle, any other movement, and/or combination thereof) on the multi-touch panel of the electronic device.

Next is step 512 at which the electronic device determines whether or not the electronic device is still receiving the enabling touch event. For example, the enabling touch event may be comprised of the user's pinky finger being pressed against the multi-touch panel, and when the pinky finger is removed from the multi-touch panel the enabling touch event may cease to exist.

Persons skilled in the art will appreciate that step 512 may be omitted in some embodiments of the present invention. Instead of requiring the enabling touch event to be a required, continuing event, the electronic device may time-out or have another mechanism or procedure for assuring that the device is only active when the user is interacting with the electronic device.

In response to the electronic device determining at step 512 that the enabling touch event is no longer occurring, process 500 proceeds to step 514. At step 514 the electronic device determines whether or not it should power down.

In response to the electronic device determining at step 514 that the electronic device should power down, process 500 advances to step 516 and ends. In response to the electronic device determining at step 514 that the electronic device should not power down, process 500 returns to step 506 and waits for an enabling touch event.

Returning to step 512, in response to the electronic device determining that the enabling touch event is still occurring, process 500 proceeds to step 518. At step 518 the electronic device determines if it has also received a navigational event. For example, while the user's pinky finger is resting on the multi-touch panel (i.e., causing the enabling touch event), the user's index finger and/or middle finger may be tapping or sliding on the multi-touch panel. In some embodiments, the tapping, sliding or any other movement performed by the index, middle or ring fingers can cause the electronic device to generate a navigational touch event. In response to the electronic device determining at step 518 that the electronic device has not received a navigational touch event, process 500 returns to step 510. In response to the electronic device determining at step 518 that it has received a navigational touch event, process 500 proceeds to step 520.

At step 520 the electronic device generates a touch signal that corresponds with the navigational touch event received at step 518. The touch signal can be sent from the touch panel's circuitry to the electronic device's processor or any other component of the electronic device. The touch signal may comprise data associated with, for example, the type of navigational touch event (e.g., tap, slide, press, circular, pinch, spread, or any combination thereof), the location of the touch event (which may be a relative and/or absolute location), and/or any other data associated with the navigational touch event.

The touch signal can cause the electronic device to navigate a menu system. The menu system may enable the electronic device to organize media and options, such as communications related options, in a logical, easy to use manner. Each menu (which can include a grouping of options) and/or each option provided by a non-visual electronic device can be associated with a particular audio cue. If the electronic device includes or is coupled to a display screen, each option and menu can be associated with various user information, such as, e.g., icons, text, images, other types of display elements, audio cues, or any combination thereof. The user information may be at least partly based on, for example, the touch signal, the current position in the menu hierarchy and the current position in a particular menu.

Step 522 follows step 520. At step 522 the electronic device determines whether the navigational touch signal is valid. A navigational touch signal may be invalid when, for example, the multi-touch panel receives a touch event that it cannot interpret or that has no corresponding function in a particular menu. For example, the user may be at a Main Menu listing of options that is the top of the menu hierarchy. When the user tries to go up the menu hierarchy (by, e.g., making a sliding movement with a ring finger), the electronic device may determine that the corresponding touch signal is invalid. In response to the electronic device determining at step 522 that the electronic touch signal is invalid, process 500 advances to step 524.

At step 524 the electronic device informs the user that the user's entry was invalid. Informing the user of an invalid entry may comprise, for example, an audio cue (such as a buzzer noise), visual cue (such as a textual message), and/or a tactile cue. In some embodiments, step 524 may be omitted and the electronic device may simply not respond to an invalid entry. After step 524, process 500 returns to step 510 and the electronic device waits for another navigational touch event.

In response to the electronic device determining at step 522 that the touch signal is valid, the electronic device generates user information and presents it to the user. The user information can include audio information, visual information and/or haptic information. One or more accessory devices (such as, e.g., an external display screen and/or speakers) may be used to assist in the presentation of user information. After step 526, process 500 returns to step 510 and the electronic device waits for another navigational touch event.

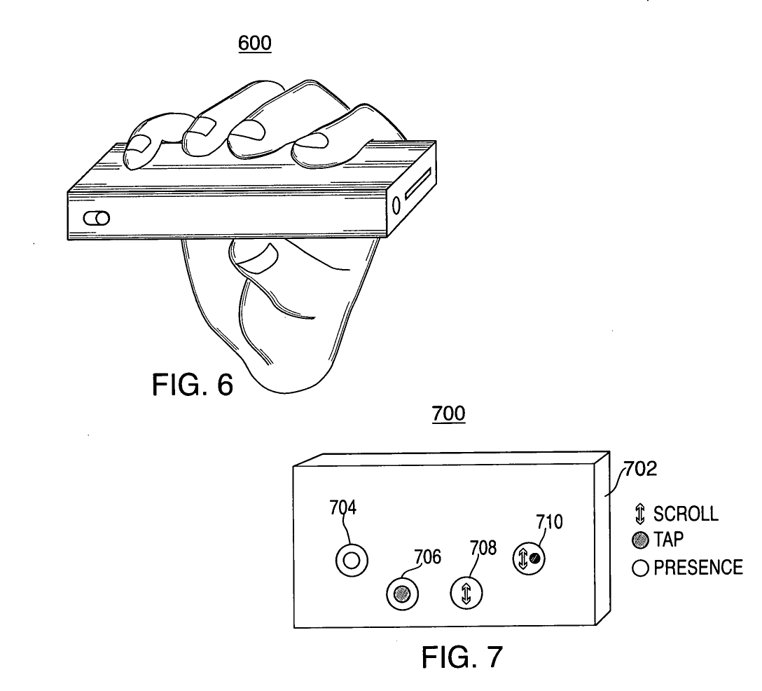

FIG. 6 shows how a hand may hold electronic device 600, which is one example of an electronic device that is in accordance with some embodiments of the present invention. Electronic device 600 is shown as a non-visual device that lacks a display screen. Persons skilled in the art will appreciate that the electronic device may be coupled to a display screen and that other embodiments of the present invention may work in conjunction with a display screen.

FIG. 7 shows electronic device 700, which may be the same as or substantially similar to electronic device 600 or any other device discussed herein.

Electronic device 700 includes multi-touch panel 702. A user may activate electronic device 700 by placing one or more fingers on multi-touch panel 702. Contact points 704, 706, 708 and 710, respectively illustrate where the user's pinky, ring, middle and index fingers may initially reside on multi-touch panel 702. The circuitry coupled to multi-touch panel 702 may convert the physical location of each contact point into an initial location data point that is stored in, for example, a storage device included in electronic device 700.

The symbols (and lack thereof), shown inside each of the contact points' circles, represent permissible types of touch events that may be performed by each of the four fingers. Persons skilled in the art will appreciate that the user's thumb and/or less than all four fingers may be utilized in other embodiments of the present invention. Persons skilled in the art will also appreciate that FIG. 7 only illustrates one embodiment of the present invention, and in other embodiments more or less types of touch events may be permissibly performed by each finger.

For example, electronic device 700 may be initially enabled in response to the user placing four fingers on multi-touch panel 702. The pinky finger's presence at contact point 704 may act as a continuing enabling touch event, which causes electronic device 700 to keep multi-touch panel 702 active. Electronic device 700 may disable multi-touch panel 702 in response to the pinky finger being removed. Contact point 704 can also be used as an anchor point for determining, for example, the relative direction of any other touch event. In other embodiments, one or more other contact points can also be used as an enabling touch event and/or as an anchor point for determining the relative direction of the movement(s) of other touch events.

The empty circle inside of contact point 704 indicates that the pinky finger can not be used to generate a navigational touch event. In the example shown in FIG. 7, the pinky finger acts solely as the enabling touch event.

The shaded circle inside of contact point 706 indicates that a valid touch signal may be generated in response to the ring finger tapping multi-touch panel 702. In the embodiment shown in FIG. 7, any other movement made by the ring finger may generate an invalid touch signal or no touch signal at all.

The arrow inside of contact point 708 indicates that a valid touch signal may be generated in response to the middle finger sliding along the surface of multi-touch panel 702. In the embodiment shown in FIG. 7, any other movement, such as a tap, made by the middle finger may be determined to be an invalid touch event.

The shaded circle and arrow inside of contact point 710 indicates that a plurality of valid touch signals may be generated in response to the index finger sliding along or touching multi-touch panel 702. When, for example, the index finger and middle finger slide on multi-touch panel 702 in the same direction at the same time, electronic device 700 may generate a permissible joint touch event. The joint touch event may be different from the touch event generated in response to, for example, the middle or ring finger individually sliding on multi-touch panel 702. In the embodiment shown in FIG. 7, any other movement, such as a circular movement, made by the index finger may generate an invalid touch signal or no touch signal at all.

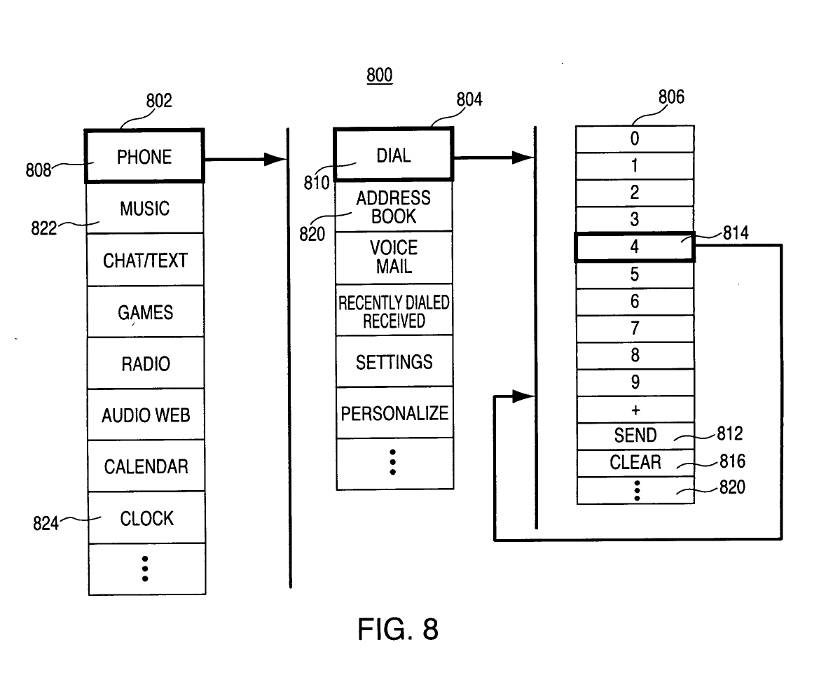

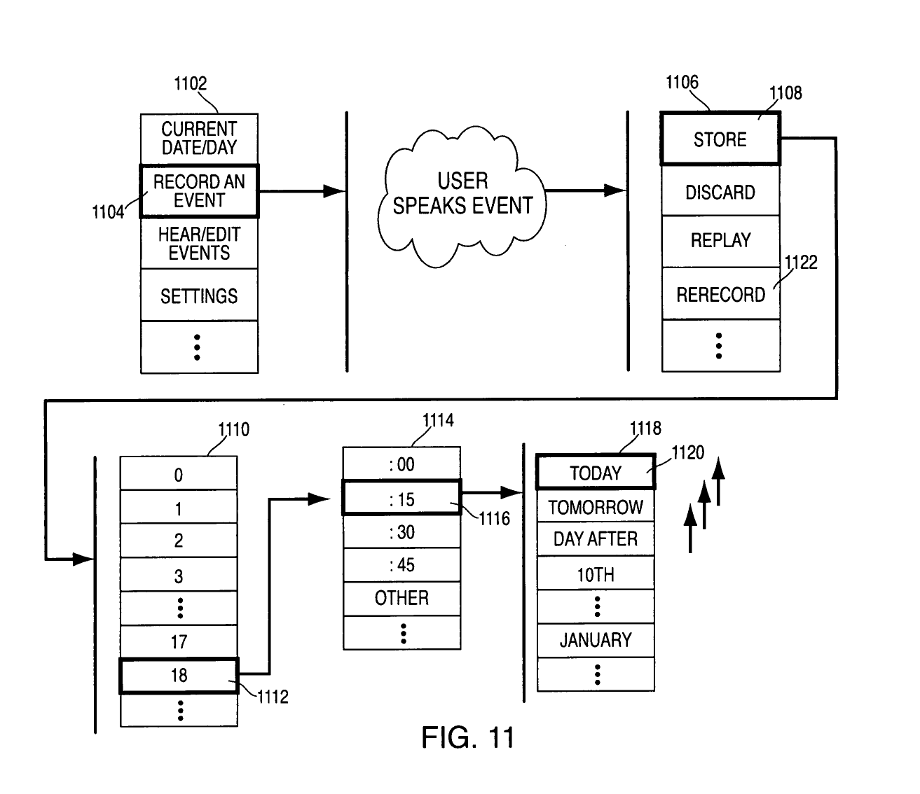

FIGS. 8-12 show exemplary navigational flows for a menu hierarchy implemented by a non-visual media device or visual media device in a non-visual mode. Further to the discussion above, a visual device may enter a non-visual mode in response to the device determining that the user cannot see the display screen (because the display screen is not functioning, the device is in the user's pocket, etc.). In addition, the navigational flows discussed in connection with FIGS. 8-12 assume that the media device only allows a limited number of permissible navigational touch events, such as the four permissible navigational touch events discussed in connection with FIG. 7. Persons skilled in the art will appreciate that the navigational flows and even the entire menu hierarchy can be modified to be simpler or more complicated depending on the electronic device on which they are implemented. (As discussed herein, the term “menu” refers to a collection of related user selectable options, and the phrase “menu hierarchy” refers to a plurality of interrelated menus.)

Some embodiments of the present invention involve mental mapping, especially the embodiments that do not require a functional display screen (such as the embodiments that utilize, e.g., a non-visual or device in a non-visual mode). Mental mapping is when the device enables a user to map a menu hierarchy mentally, without any visual stimuli. Mental mapping can occur in response to a device associating and playing a particular audio cue or other sound each time a user accesses a particular menu. A device that enables mental mapping can also enable the user to quickly navigate a complex menu hierarchy, even in the absence of a visual user interface.

The audio cues can be predetermined by the device and/or configured by a user. The audio cues can also be played by a device prior to the device providing a verbose explanation of the menu and/or each menu option. In some embodiments, the audio cues can be coordinated with the menu hierarchy. For example, the audio cue's pitch and/or frequency can become progressively deeper as the user goes down this menu hierarchy, and progressively higher as the user goes back up. In addition, each sub-menu hierarchy can have an unique theme of audio cues. For example, phone-related sub-menus can have dial tone-like chimes, while game-related sub-menus can have more playful sounding chimes presented as the user steps through each menu.

Each option associated with each menu can also have an unique audio cue. For example, options associated with a musical or other recording can have an audio cue that is a snippet of the song or other recording. As another example, each address book contact's audio cue can be in that person's voice or a simulated voice generated from an analysis of a voice snippet recorded during the last call with that person. See, e.g., U.S. patent application Ser. No. 11/981,866, entitled “Systems and Methods for Controlling Pre-Communications Interactions” (client docket no. P5335US1), filed on Oct. 31, 2007, which is hereby incorporated by reference in its entirety.

In some embodiments, the electronic device can have the audio cues linger longer when the device is in a non-visual mode (as compared to when it is in a visual mode), which can help the device correctly match a selection input with the desired option.

FIG. 8 shows navigational flow 800. Navigational flow 800 includes main menu 802, phone menu 804 and numbers menu 806. Main menu 802 can be associated with a particular audio cue, sometimes referred to herein as the main menu chime. The main menu chime, like any other audio cue discussed herein, can be any type of sound (e.g., system generated, user generated, prerecorded, downloaded, and/or any other type, portion or combination of sound).

Main menu 802 may be accessed in response to, e.g., an enabling touch event, such as one or more fingers touching a portable media device simultaneously. Main menu 802 can also be accessed like any other menu discussed herein, for example, in response to the user indicating a desire to access the main menu (by, e.g., pressing a dedicated main menu or home button), or a voice command. Accessing the main menu, like any other menu discussed herein, may include retrieving main menu data from a storage device (temporary or permanent), processing the data into main menu audio information, and playing back the main menu audio information. The main menu chime may be included in the main menu audio information.

In some embodiments, the electronic device may announce a menu's options to the user. For example, the electronic device may audibly list each of the main menu options in plain English. The electronic device may, for example, provide the following audio information to the user in response to the main menu being accessed: main menu chime, “Main menu . . . phone . . . music . . . chat text . . . games . . . radio . . . ” and so on until the electronic device has announced each item in the list of options. (As used above, the quotes imply words that are verbalized to the user, and . . . indicates a delay of a given amount of time, such as 1 second, which may allow the user enough time to select an option before the next option is announced.) Persons skilled in the art will appreciate that the electronic device may speak to the user in any language, and that discussion of the present invention only references the English language to avoid unnecessarily overcomplicating this discussion.

In other embodiments, the device may only announce each option and/or play each option's audio cue in response to the user scrolling through the menu options. For example, the electronic device may play the following audio information to the user in response to the main menu being accessed: main menu chime, “Main menu . . . phone.” The electronic device may not announce the word “music” or “radio” until the electronic device receives a navigational touch event from the user that indicates that the user wants to scroll through the list of options. A single scroll down touch event may consist of, for example, the user sliding his index finger in downward direction (e.g., towards the user's palm) across the multi-touch input component. In response, the electronic device may generate a single scroll down touch signal. The user may indicate a desire to scroll by, for example, more than one option (such as, e.g., three options) at a time by moving his middle finger in downward direction across the multi-touch input component. In response, the electronic device may generate a multiple scroll down touch signal. In addition, the user may indicate a desire to scroll down even faster (such as, e.g., ten options at a time) by simultaneously moving both his index finger and middle finger in downward direction across the multi-touch input component. In response, the electronic device may generate a fast scroll down touch signal. The single scroll down touch signal, multiple scroll down touch signal and fast scroll down touch signal may cause the electronic device to announce an option further down the list that can be selected. One skilled in the art will appreciate that similar touch events in the opposite direction may create an upward touch signal that causes the electronic device to parse back up through the options in the list.

The user can indicate a desire to select an option by, e.g., tapping the electronic device's multi-touch input component with the user's index finger. The electronic device may interpret an index finger tap as a selection of phone option 808 when, for example, the tap that occurs (1) after the electronic device plays the main menu chime and/or says “phone” and (2) before the electronic device announces another option to the user. The electronic device may also provide audio feedback that confirms the user selection of any or all options. For example, in response to the user selecting phone option 808, the electronic device may announce in English “phone” or play a phone-related audio selection cue.

In some embodiments, the user does not have to wait for the first option in the menu to be announced, because the electronic device can be programmed to have the first option in the menu be the default option. For example, the user may quickly tap his index finger 3 times after enabling the multi-touch input component and, in response, the electronic device will dial the number 0 after stepping through main menu 802, phone menu 804 and numbers menu 806.

In some embodiments, the user may also indicate a desire to select an option by speaking into a microphone that is coupled to and/or integrated into the electronic device. For example, the electronic device may utilize one or more voice recognition commands to select phone option 808 after, e.g., the electronic device plays the main menu chime.

Phone menu 804 can be presented to the user in response to the electronic device selecting phone option 808. Phone menu 804 includes a list of options associated with telephone functions. Phone menu 804 may have a phone menu chime associated with it. The phone menu chime may be the same as or different from any other audio cue. The options associated with phone menu 804 may be presented to the user in any manner, such as, for example, those discussed above. In response to the user indicating a desire to select dial option 810, the electronic device may proceed to numbers menu 806.

Numbers menu 806 includes options that are associated with entering and dialing a telephone number. Further to the above discussion, numbers menu 806 can be associated with an audio cue that is similar to, but deeper in pitch than the phone menu chime. The user may select the options included in numbers menu 806 to dial a telephone number one digit at a time and then select send option 812. For example, if the user wanted to dial 411, the user would first indicate a desire to select option 814.

To indicate a desire to select option 814 by tapping the electronic device with his index finger, the user must first scroll down to option 814. As discussed above, the user may indicate a desire to scroll down a menu's options list by, for example, sliding his index finger, middle finger or both in a downward direction across the multi-touch input component. After the electronic device announces “four,” the user may tap his index finger on the multi-touch input component and the electronic device can, in response, generate a selection touch event. The electronic device will then store the number four in cache and return to numbers menu 806. This process can be repeated until, for example, the user indicates a desire to select send option 812. Selection of send option 812 may include communicating with a telephone network, dialing the numbers stored in cache, etc.

In response to, e.g., clear option 816 being selected, the electronic device may remove the last number or all number from cache. Block 820 indicates that additional options may be included in numbers menu 806. For examples, an additional option may be a back option (which moves up a menu in the hierarchy, e.g., from numbers menu 806 to phone menu 804). The user may also indicate a desire to go back up the menu hierarchy by tapping the electronic device's multi-touch input component with his ring finger, which can cause the electronic device to generate a back touch signal.

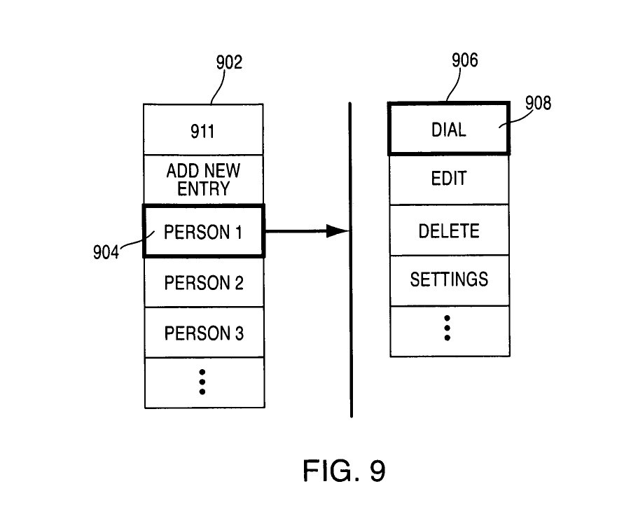

In response to the user selecting address book option 820, the electronic device may access and present other audible information associated with contacts menu 902 shown in FIG. 9. The user may scroll down to person option 904 by sliding one or more fingers on the multi-touch input component and indicate a desire to select person option 904 by tapping his index finger on the multi-touch input component. In response, the electronic device can select person option 904 and access contact options menu 906. Because dial option 908 is first in the list of contact options associated with that person, the user may tap the multi-touch input component with his index finger and, in response, the electronic device can initiate a telephone call between the electronic device and the telephone of the person associated with person option 904.

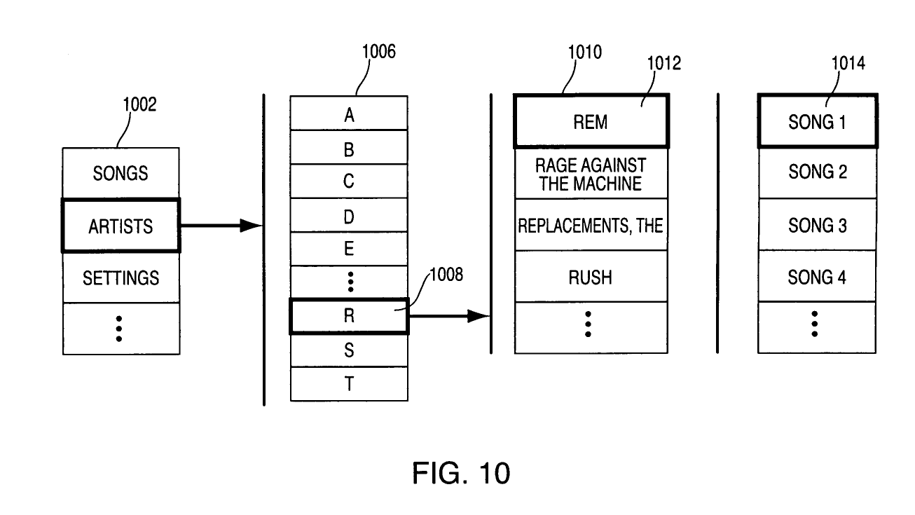

Returning to main menu 802, the user may also scroll down and indicate a desire to select music option 822. In response, the electronic device may access and present options and other audible information associated with music menu 1002 shown in FIG. 10. The user may scroll down to artists option 1004 by sliding one or more fingers on the multi-touch input component and indicate a desire to select artists option 1004 by tapping his index finger on the multi-touch input component. In response, the electronic device can audibly confirm the selection and access letter options menu 1006. The user may then use one or more fingers, or any combination thereof, to scroll to the letter the user is interested in and, upon hearing the first letter of the artist the user would like to listen to, indicate a desire to select a letter. For example, the user can use a combination of fast scroll and single scroll touches to get down to letter option 1008, and then tap the multi-touch input component to indicate a desire to select letter option 1008.

In response to letter option 1008 being selected, the electronic device may access and present options and other audible information associated with artists menu 1010. If the user were to tap his index finger, even before the electronic device is still presenting, for example, the audio cue associated with artists menu 1010, the electronic device can select option 1012. The electronic device would then present options and other audible information (song as, e.g., song snippets) associated with songs menu 1014.

Returning to main menu 802 of FIG. 8, the user may scroll down and indicate a desire to select calendar option 824. In response, the electronic device can present options and other audible information associated with calendar menu 1102. Record option 1104 can be included in calendar menu 1102 and, in response to record option 1104 being selected, the electronic device may prompt the user to dictate an audible calendar entry. When the user is finished speaking, or after a predetermined period of time expires, the electronic device can present options and audible information associated with voice recording menu 1106. Store option 1108 can be included recording menu 1106 and, in response to store option 1108 being selected, the electronic device may present hour menu 1110 to the user. The user can scroll down to hour option 1112 and select it. Although hour menu 1110 is illustrated as including an option labeled 0-23 for each hour, persons skilled in the art will appreciate that one or two 12 hour based menus with or without AM and PM designations may also be provided.

In response to hour option 1112 being selected, the electronic device can present minute menu 1114. The options included in minute menu 1114 can include, for example, minute option 1116. In response to the user scrolling to and selecting minute option 1116, the electronic device can present day menu 1118. As the user scrolls down day menu 1118, the electronic device can present ever broader options to the user. In this manner, day menu 1118 can include options associated with specific days and/or dates as well as months, even years farther down the list of options.

If at any time the user decides to navigate up the menu hierarchy, the user may simply tap his ring finger on the multi-touch input component. For example, while in day menu 1118, the user may decide to rerecord the calendar event. In response to the user tapping his ring finger three times, the electronic can return to recording menu 1106. The user can then scroll down to and select rerecord option 1122.

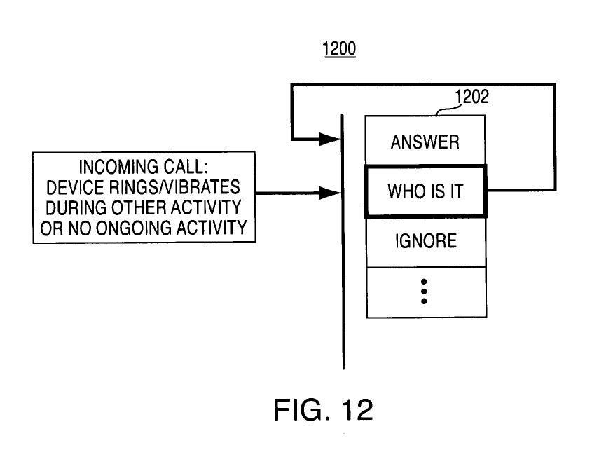

FIG. 12 shows an exemplary navigational flow that can be used when the electronic device receives a telephone call. The electronic device can first announce who is calling if the number of the person who is calling is stored in the user's contact list. In some embodiments, the electronic device can announce who is calling in the voice of the person that is calling. For example, when Angela calls, the electronic device can play a prerecorded audio data file that says, “Hey, it's me Angela” in Angela's voice. In other embodiments, rather than use a prerecorded audio file of Angela actually talking, the electronic device can create a simulated voice that is generated from an analysis of a voice snippet recorded during the last call the user had with Angela.

In response to the electronic device determining that the incoming call is from an unknown number, the electronic device may access menu 1202 and announce the corresponding options to the user. The user may simply tap the multi-touch component to answer the call, or scroll down to, e.g., caller ID option 1202. In response to caller ID option 1202 being selected, the electronic device may announce the number (or name if it is available) of the person who is calling. The user can be prompted with menu 1202 again, until the phone stops ringing.

The above disclosure is meant to be exemplary and limiting. Persons skilled in the art will appreciate that there are additional features in accordance with the present invention that have not been discussed in great detail herein. For example, text and other electronic messages could be presented to the user as audio information with the use of text to audio conversion software. Accordingly, only the claims that follow are meant to set the bounds as to what the present invention includes.

What is claimed is:

1. A method of utilizing a multi-touch input component to navigate a menu hierarchy of an electronic device, comprising:
generating one or more audio signals that enable a user to navigate the menu hierarchy absent a functioning visual display component;
receiving a navigational touch event;
generating a touch signal that corresponds with the navigational touch event;
processing the touch signal; and
generating one or more responsive audio signals.

2. The method of claim 1 further comprising audibly presenting the one or more responsive audio signals to the user, wherein the one or more responsive audio signals comprises an option included in the menu hierarchy.

3. The method of claim 1, wherein the electronic device generates the one or more audio signals in response to determining that a visual display component of the electronic device is not functioning.

4. The method of claim 3, wherein the electronic device automatically determines that the visual display component of the electronic device is not functioning because the electronic device is operating in a non-visual mode.

5. The method of claim 1 further comprising initiating a telephone call in response to the touch signal.

6. The method of claim 1 further comprising wirelessly pairing with another device using the Bluetooth™ protocol.

7. The method of claim 1 further comprising playing back a media file in response to the touch signal.

8. The method of claim 1 further comprising:
receiving audio signals; and
processing the audio signals into digital data.

9. The system of claim 9 further comprising providing haptic feedback.

10. The method of claim 1 further comprising only receiving the navigational touch event while an enabling touch event is occurring.

11. The method of claim 1 further comprising deactivating the multi-touch input component in response to a cessation of an enabling touch event.

12. A system including an electronic device that can process physical stimuli into electrical data and enable a user to navigate a menu hierarchy, the system comprising:
a storage component that stores menu data;
a multi-touch user input component, wherein the multi-touch user input component:
lacks a functional visual display component;
receives one or more navigational touch events; and
generates a touch signal that corresponds with the navigational touch event;
a processor that:
accesses the menu data;
generates one or more audio signals based on the menu data, wherein the audio signals enable a user to navigate the menu hierarchy absent a functioning visual display component;
processes the touch signal; and
generates one or more responsive audio signals.

13. The system of claim 12 further comprising a speaker that audibly presents the one or more responsive audio signals to the user, wherein the one or more responsive audio signals comprises an option included in the menu hierarchy.

14. The system of claim 12, wherein the processor generates one or more audio signals in response to the processor determining that the multi-touch input component lacks a functioning visual display component.

15. The system of claim 14, wherein the processor determines that the multi-touch input component lacks a functioning visual display component because the electronic device is operating in a non-visual mode.

16. The system of claim 12 further comprising at least one wireless communications component.

17. The system of claim 16, wherein the at least one wireless communications component includes a cellular telephone antenna.

18. The system of claim 12 further comprising a CODEC for playing a media file.

19. The system of claim 12 further comprising a microphone.

20. The system of claim 9 further comprising a vibration generator.

21. The system of claim 12, wherein the multi-touch user input component is enabled while the multi-touch user input component is receiving an enabling touch event.

22. The system of claim 12, wherein the multi-touch user input component is disabled in response to a cessation of an enabling touch event.

23. A method of utilizing a multi-touch input component to navigate a menu hierarchy of an electronic device, comprising:
omitting a visual user interface;
compiling a menu that includes at least two menu options;
announcing a first menu option to the user;
receiving a touch event before a second menu option is announced;
in response to receiving the touch event before the second menu option is announced, determining that the user indicated a desire to select the first menu option; and
generating an audible response that corresponds with the first menu option.

24. A method of utilizing a multi-touch input component to navigate a menu system of an electronic device, comprising:
operating an opaque multi-touch panel in the absence of a visual display, wherein the opaque multi-touch panel enables non-visual navigation of a menu system;
determining at least two initial points of contact, wherein each of the initial points of contact corresponds with where a finger tip is located on the opaque multi-touch panel;
generating at least two initial location data points, wherein each of the initial location data points identifies each of the initial points of contact;
storing the initial location data points;
detecting movement of a finger tip;
determining which finger tip moved;
determining the type of movement;
determining the relative direction of the movement based on one of the at least two initial location data points;
in response to determining which finger tip moved, the type of movement, and relative direction of the movement, generating a touch signal; and
generating an audio signal based on the touch signal.

25. A system including an electronic device that can process physical stimuli into electrical data and enable a user to navigate a menu hierarchy, the system comprising:
an opaque multi-touch input component, wherein the opaque multi-touch input component:
enables non-visual navigation of a menu system;
determines at least two initial points of contact, wherein each of the initial points of contact corresponds with where a finger tip is located on the opaque multi-touch input component;
generates at least two initial location data points, wherein each of the initial location data points identifies each of the initial points of contact;
detects movement of a finger tip;
determines which finger tip moved;
determines the type of movement;
determines the relative direction of the movement based on one of the at least two initial location data points; and
generates a touch signal in response to determining which finger tip moved, the type of movement and relative direction of the movement;
a storage component that:
stores menu data; and
stores the initial location data points;
a processor that generates an audio signal based on the touch signal.
